(19) United States
(12) Patent Application Publication
(10) Pub. No.: US 2009/0288566 A1
(43) Pub. Date: Nov. 26, 2009

(54) Method for Producing Printing Stencils, Particularly for Screen Printing Methods, and a Stencil Device

(75) Inventors: Bernd Maihoefer, Reutlingen (DE); Andreas Meier, Pfullingen (DE); Mark Leverkoehne, Post Vyskytna Nad Jilavou (CZ); Ulrich Speh, Steinenbronn (DE); Gunther Lieb, Dettenhausen (DE); Alexandra Dirscherl, Pfullingen (DE); Joerg Schaefer, Holzgerlingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/087,254

(22) PCT Filed: Jan. 2, 2007
(86) PCT No.: PCT/EP2007/050010

§ 371 Date: Feb. 2, 2009

(30) Foreign Application Priority Data
Dec. 30, 2005 (DE) 10 2005 063 282.3

(51) Int. Cl. B05C 17/08; B41M 1/12

(52) U.S. Cl. 101/126; 101/129

(57) ABSTRACT

A method for producing printing stencils, especially for screen printing methods, and particularly those for use in filling at least one contact hole formed in a printed-circuit board, a pattern artwork being reproduced on the stencil, which corresponds to an arrangement of contact holes on the printed-circuit board. It is provided that the pattern artwork reproduced on the stencil be produced in the same working process, especially a punching process, using a cluster punching tool, as the at least one contact hole on the printed-circuit board. Also, a stencil device is provided.

### BACKGROUND INFORMATION

Integrated electronic components usually include at least one printed-circuit board, on whose front side electronic power components are situated. It is known, particularly when using a printed-circuit board material made of plastic or ceramic foils, that one may bore or punch contact holes or through contacting into the printed-circuit boards, whose diameters tend to be in the p range and which are designated as μ vias (or microvias). The vias are provided on the one hand to support vertical heat transport of the electronic power components situated on the front side of the mounting board to the back side. Such thermal through contacting (or thermal vias) are developed as small holes or blind holes, which may be generated using laser technology or mechanically, using a microbore or punching needle, and used for heat conduction. On the other hand, the through contacting may be provided for the electrical connection of the components situated on the front side of the printed-circuit board of a circuit configuration, and of a metallic printed circuit trace structure applied on it, to its back side (so-called electrical vias). In the stencil printing process the previously generated vias are filled with a conductive paste.

In order to carry out this so-called “via-filling process”, especially in the case of ceramic substrates (or ceramic tape), stencils are used which are made by laser technology, for example. It is disadvantageous, in this instance, that manufacturing tolerances of stamped vias in ceramic tape, for example, as well as tolerances that are created during the production process of these via-fill stencils, are cumulative, which may have unfavorable effects on the via-fill process.

### SUMMARY OF THE INVENTION

In a method for producing printing stencils, especially those to be used in filling up at least one contact hole formed in a printed-circuit board, according to the present invention, a pattern artwork reproduced on the stencil is produced in the same working process, preferably by cluster punching, as a contact hole on the printed-circuit board. In this context, a pattern artwork is reproduced on the stencil which corresponds to an arrangement of contact holes on the printed-circuit board. What is particularly advantageous, in this instance, is that production tolerances may be eliminated.

The stencil or the pattern artwork on the stencil may preferably be produced using the same tool as for the contact hole. The pattern artwork is particularly preferably punched, the punching process being carried out preferably using a cluster punching tool. Because the stencil is produced using the same cluster punching tool as the vias in the ceramic tape, stencils and vias are developed congruently, which is advantageous for the filling of the vias.

One stencil device according to the present invention, having a printing stencil, particularly for use in filling at least one contact hole formed in a printed-circuit board, is able to be produced in the same working process as the contact hole, particularly in a punching process. The holes on the pattern artwork are preferably punched, for instance, using a cluster punching tool. Disadvantageous production tolerances may favorably be prevented by using such a stencil. Consequently, the stencil becomes compatible with the greatest requirements on the accuracy of the position and size of the vias.

### BRIEF DESCRIPTION OF THE DRAWINGS

FIGS. 1a and 1b show a production process of a stencil according to the present invention in a punching tool, before the punching process (FIG. 1a) and after the punching process (FIG. 1b).

FIG. 2 shows a filling process of vias in a via-fill process using a stencil produced according to the related art.

FIG. 3 shows the via-fill process using a specific embodiment according to the present invention of a stencil.

### DETAILED DESCRIPTION

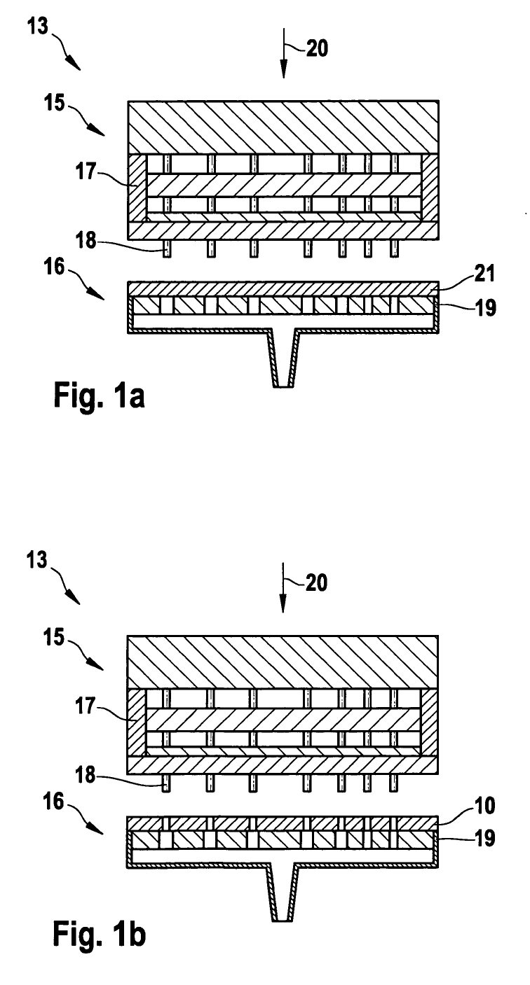

In FIGS. 1a and 1b, a production process of a stencil 10, according to the present invention, using a stamping tool 13, is shown schematically. Stamping tool 13 includes an upper part 15 and a lower part 16. Upper part 15 includes a punch 17 as well as punching needles 18, which are able to be moved back and forth in punching direction 20, and which punch an element arranged on a cutting die 19 according to a specified cutting pattern. A still unprocessed stencil blank 21 is clamped between upper part 15 and lower part 16 in FIG. 1a. In FIG. 1b, stencil blank 21 has been punched, and is able to be used as a stencil 10, for instance, in a via-fill process.

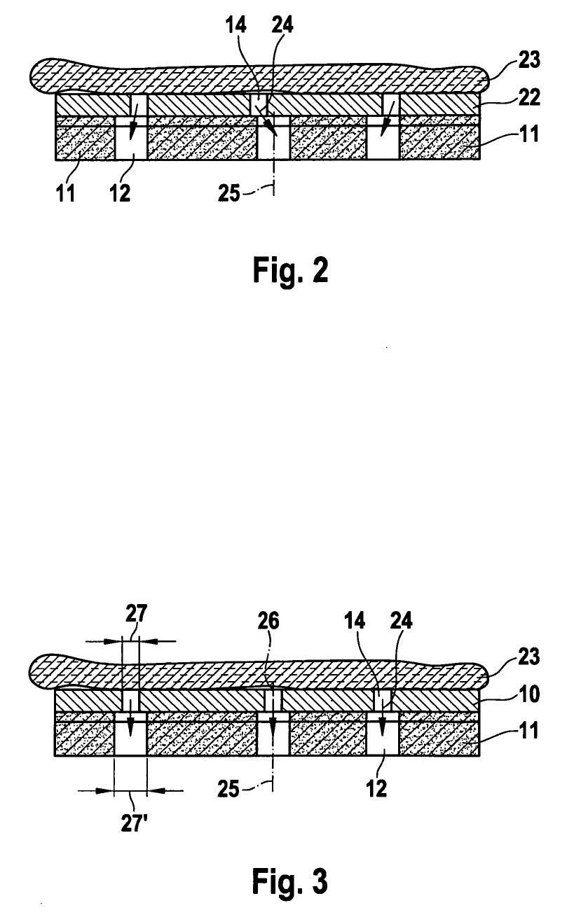

FIG. 2 shows a filling process of vias in a via-fill process, using a stencil 22, produced according to the related art, for example, by laser. Printed-circuit board 11 is formed particularly of a ceramic substrate or ceramic tape, and has contact holes 12 in the form of blind holes or vias. The pattern artwork of lasered stencil 22 does not exactly correspond to the arrangement of vias 12 in printed-circuit board 11, so that openings 14 in stencil 22 do not coincide with vias 12. A filling process of vias 12 using a paste 23 is made difficult by this inaccuracy, for example, because a filling direction 24 does not take place along a via axis 25, but at an angle thereto. There is thus the danger that vias 12 are not completely filled with paste 23 after the filling process, so that electrical and thermal interruptions may occur.

FIG. 3 shows a stencil 10 according to the present invention, a pattern artwork reproduced on stencil 10 being produced in the same work process as an arrangement of vias on a printed-circuit board 11. In particular, the pattern artwork on stencil 10 and vias 12 on printed-circuit board 11 are produced using the same tool 13. They are produced or punched using a punching tool, in particular. The tolerances accumulating during the production of vias 12 and stencil 10 are thereby favorably eliminated, and a center point 26 of holes 14 on the pattern artwork of stencil 10 coincides in each case with central axis 25 of individual vias 12.

The material of which stencil 10 is made may be selected so that openings 14 formed on the pattern artwork have a smaller diameter 27 than a diameter 27′ of vias 12.

Stencil 10 according to the present invention may be made to coincide with vias 12 before the filling process. As soon as stencil 10 is correctly placed, vias 12 may be filled precisely using paste 23, under-filling them being avoided. After the filling of vias 12 at the end of the blading process, stencil 10 is lifted off again.

1-5. (canceled)

6. A method for producing printing stencils for use in filling at least one contact hole formed in a printed-circuit board, the method comprising:
reproducing a pattern artwork on a stencil which corresponds to an arrangement of contact holes on the printed-circuit board; and
producing the pattern artwork reproduced on the stencil in the same working process as the at least one contact hole on the printed-circuit board.

7. The method according to claim 6, wherein the method is for producing printing stencils for screen printing methods.

8. The method according to claim 6, wherein the stencil is produced using the same tool as for the contact hole.

9. The method according to claim 6, wherein the stencil is punched.

10. A stencil device for use in filling at least one contact hole formed in a printed-circuit board, comprising:
a printing stencil, a pattern artwork being reproduced on the stencil which corresponds to an arrangement of contact holes on the printed-circuit board, the pattern artwork of the stencil being made of at least one hole which is produced in the same working process as the contact hole.

11. The method according to claim 10, wherein the holes are punched on the stencil.
